(19) United States
(12) Patent Application Publication
(10) Pub. No.: US 2002/0119428 A1
(43) Pub. Date: Aug. 29, 2002

(54) Computer-assisted haircutting method

(76) Inventor: Jean-Jacques Vitale, Saint Jean De Vedas (FR)

Correspondence Address: JACOBSON HOLMAN PLLC, 400 SEVENTH STREET N.W., SUITE 600, WASHINGTON, DC, 20004, US

(21) Appl. No.: 10/068,882

(22) Filed: Feb. 11, 2002

Related U.S. Application Data
(63) Continuation of application No. PCT/FR00/02235, filed on Aug. 3, 2000.

(30) Foreign Application Priority Data
Aug. 11, 1999 (FR) 99/10459

(51) Int. Cl. G09B 19/10

(52) U.S. Cl. 434/94

(57) ABSTRACT

The invention relates to a computer-assisted haircutting method, comprising:

a) using an external data carrier (3), CD-ROM type, containing a selected haircutting technique;

b) inputting into a computer (1), audio and video data contained in said selected data carrier (3) and displaying step by step a program;

c) carrying out the selected haircutting technique step by step, lock by lock (5), by placing the scissors in an orientation and dimensional position displayed on said display screen (2) in the form of cutting lines (6).

The method in question can use in addition:

a camera (7) visualizing on said screen (2), in overlay, hair (8) of the client, the locks of hair (5) to be seized, the scissors and the cutting lines (6).

an independent transparent screen (9) arranged in front of a hairdresser's eyes whereon are displayed said cutting lines (6) in superposition with said client's face.

This invention relates to a computer-assisted haircutting method. The proposed method is of the kind using essentially a computer-based equipment, adapted operating software, a video camera and a visualization screen.

The closest state of the art is described in the U.S. Pat. No. 4,823,285 concerning to a method for previewing a subject on a computer screen comprising stored in a memory a plurality of hairstyles. The subject's face is outlined and the subject's hair is removed and replaced with one of the new hairstyles stored in the computer's databank. The image thus obtained is then printed in order to be shown to the client.

In contrast the method according to the invention, aims at analyzing the objectives of a haircut and to assist the execution by means of a computer and image analysis; the hairdresser continuing to cut the hairs normally.

The method is supported on an information-system based on new multimedia technologies. It has the principal advantage compared to a traditional means on videocassette, to be interactive and to bring the information more sophisticated thanks to the multimedia techniques.

The user can thus be guided or auto trained in real time along its training. The device associated with this technique addresses to the market formation (schools, institutes) and with that of hairdresser's salons.

The principle of the invention can obviously be extended with some function “on-line ” via the INTERNET network.

The haircutting method according to the invention is characterized in that it comprises the steps of:

a) using an external data carrier in particular an interactive CD-ROM, containing a haircutting technique selected by a client starting from a computer or paper based data base;

b) inputting into said computer, by means of an adapted reader, audio and video data contained in said selected data carrier and displaying step by step a program contained in said data carrier by means of a remote control;

c) carrying out said selected haircutting technique step-by-step, lock-by-lock, by placing scissors in an orientation and dimensional position displayed on said display screen in form of cutting lines.

The method further consists in using:

a camera which shows on the screen, in superposition and in real time, the client's head of hair, the lock of hair to seize, the scissors and the line of cut corresponding;

a transparent screen (9) arranged in front of a hairdresser's eyes whereon are displayed said cutting lines (6) in superposition with the face of said client and an audio device (10) ready to direct a cutting operation, lock by lock.

The characteristics and the of the invention will appear more clearly from the detailed description which follows of at least one embodiment shown on the attached drawings:

In said drawings:

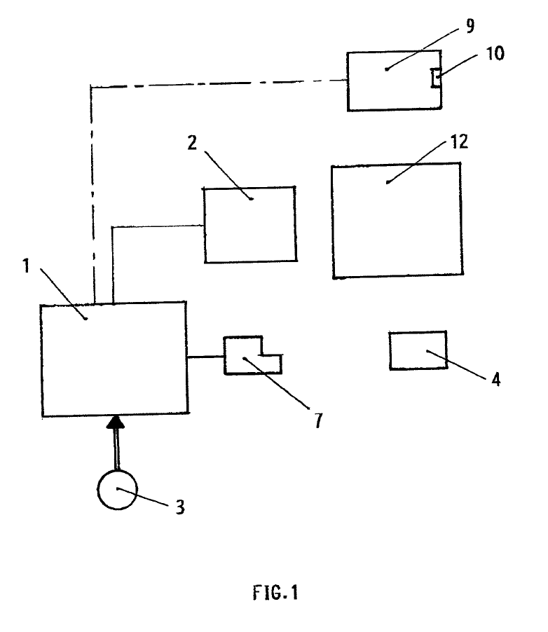

FIG. 1 is a sight diagrammatic of various module entering in the composition of the device according to the invention;

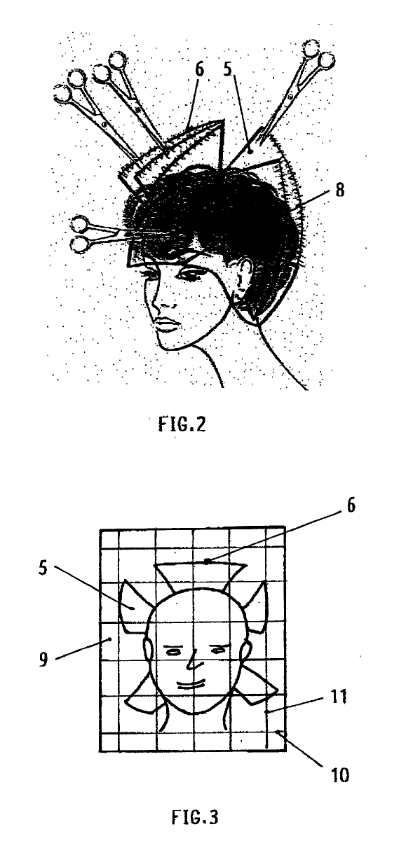

FIG. 2 is a perspective view of the face and some hairstyle of a client with in superposition the lock to cut;

FIG. 3 is a front view of the face and some locks of a client to cut out on a screen with squaring.

The haircutting method according to the invention use essentially an equipment (1) computer based, a suitable operating software and a screen of visualization (2).

It is characterized in that it comprises the steps of:

a) using an external data carrier (3) in particular an interactive CD-ROM, containing a haircutting technique selected by a client starting from a computer or paper based data base;

b) inputting into said computer (1), by means of an adapted reader, audio and video data contained in said selected data carrier (3) and displaying step by step a program contained in said data carrier by means of a remote control (4);

c) carrying out said selected haircutting technique step-by-step, lock by lock (5), by placing scissors in an orientation and dimensional position displayed on said display screen (2) in form of cutting lines (6).

According to an alternative embodiment of the invention, the method in question uses, in addition, a camera (7) which shows on said display screen (2), in an overlaying arrangement, a client's head of hair (8), locks of hair to be seized (5), said scissors and said corresponding cutting lines (6).

According to another alternative embodiment of the invention, the method in question uses, in addition, a transparent screen (9) arranged in front of a hairdresser's eyes whereon are displayed said cutting lines (6), by luminous ray for example, in superposition with the face of said client (considered viewed directly through the aforesaid screen) and an audio device (10) ready to direct a cutting operation, lock by lock.

According to an embodiment of the invention the aforementioned method shows on said additional screen (9) the position of a hand referred to said client's scalp to correctly seize said locks of hair.

According to another embodiment of the invention the cited method uses in addition a camera (7) that transmits to said computer (1) information about said client's head of hair so as to guide in real time and in full-scale said cutting operation.

According to other embodiments of the invention:

the screens (2) and (9) comprise horizontal lines (10) and verticals lines (11) forming a squaring;

the remote control integrates several functions chosen among the following ones: backward return, freeze frame, restarting, slowed down run, accelerated run;

the remote control integrates several functions chosen among the following ones: large plan, top view, side view, back sight, front view.

The production of the multimedia CD-Rom rests on the current digital audio and video techniques, the virtual assembly to define and the desired special effects.

The device for carrying out the method according to the invention, can be presented in various forms:

it can comprise a directional screen adapted to the workstation integrating or not the armchair of the hairdresser;

the computer unit, display screen and camera can be adapted to the workstation adopting the configuration of a multimedia terminal integrating or not the armchair of the hairdresser.

The user has the possibility, before the use of the system, to add own sound or textual comments. In all the cases an audio device could guide him or her.

The advantages of such a method are numerous:

setting in confidence of the client by the guarantee of obtaining a fast and effective cut and corresponding to the choice carried out;

guarantee of the client to find, if he wishes it, the same cut the next time, either in the same hairdresser's salon, or in another salon having the same equipment;

guarantee for the inexperienced hairdresser of a neat work;

effective tool for training of the new hairdressers.

Of course, the invention is not limited to the described and represented embodiments for which one will be able to envisage other alternatives, in particular in the choice of the types of cut, of the external data carriers, the operating software, the data-methoding sets used, the means of visualization and the programs of cut without for that leaving the framework of the invention. Moreover, the method and the associated device could be extended to any application where one will have to reproduce a part or an object starting from a well defined gauge (by machining or all other means).

1- Computer-assisted haircutting method of the kind essentially using a computer based equipment (1), an adapted operating software, a video camera and a display screen (2), characterized in that it comprises the steps of:
a) using an external data carrier (3) in particular an interactive CD-ROM, containing a haircutting technique selected by a client starting from a computer or paper based data base;
b) inputting into said computer (1), by means of an adapted reader, audio and video data contained in said selected data carrier (3) and displaying step by step a program contained in said data carrier by means of a remote control (4);
c) carrying out said selected haircutting technique step by step, lock by lock (5), by placing scissors in an orientation and dimensional position displayed on said display screen (2) in form of cutting lines (6).

2- Method, according to claim 1, characterized in that it further uses a camera (7) which shows on said display screen (2), in an overlaying arrangement, a client's head of hair (8), locks of hair to be seized (5), said scissors and said corresponding cutting lines (6).

3- Method, according to claim 1, characterized in that it further uses a transparent screen (9) arranged in front of a hairdresser's eyes whereon are displayed said cutting lines (6) in superposition with said face of said client and an audio device (10) ready to direct a cutting operation, lock by lock.

4- Method, according to claim 3, characterized in that it further comprises visualizing on said additional screen (9) the position of a hand referred to said client's scalp to correctly seize said locks of hair.

5- Method, according to the claim 3 or claim 4, characterized in that it consists in using, in addition, a camera (7) that transmits to said computer (1) information about said client's head of hair so as to guide in real time and in full-scale said cutting operation.

6- Method, according to any of the preceding claims, characterized in that said screens (2) and (9) comprise horizontal lines (10) and verticals lines (11) forming a squaring.

7- Method, according to any of the preceding claims, characterized in that it comprises integrating in the remote control several functions chosen among the following ones: backward return, freeze frame, restarting, slowed down run, accelerated run.

8- Method, according to any of claims 1 to 6, characterized in that it comprises integrating in said remote control several functions chosen among the following ones: large plan, top view, side view, back sight, front view.
